(19) United States
(12) Patent Application Publication
(10) Pub. No.: US 2016/0158983 A1
(43) Pub. Date: Jun. 9, 2016

(54) PERIMETER EJECTION OF AN INJECTION MOLDED MATERIAL

(71) Applicant: Douglas Christopher Hepler, Rochester, NY (US)

(72) Inventor: Douglas Christopher Hepler, Rochester, NY (US)

(73) Assignee: POLYSHOT CORPORATION, West Henrietta, NY (US)

(21) Appl. No.: 14/558,761

(22) Filed: Dec. 3, 2014

(51) Int. Cl. B29C 45/40; A23K 1/00

(52) U.S. Cl. CPC B29C 45/401; A23K 1/003

(57) ABSTRACT

The present invention relates to a perimeter ejector system for an injection molding apparatus comprising: a mold plate, housing a mold cavity consisting a molded material; and at least one lifting pin configured to extend through at least one corner or edge of the mold cavity, in order to eject the molded material off the cavity space. The lifting pin further comprises a push surface shaped to match the profile of the mold cavity, thus forming an integral part of the mold cavity.

### FIELD OF THE INVENTION

The present invention generally relates to injection molding technology, and more specifically, to perimeter ejection of injection molded materials, off a mold cavity without damaging the molded material in its uncured or non-solidified state.

### BACKGROUND OF THE INVENTION

Injection molding is a manufacturing process for producing molded parts or molded products from materials including thermoplastic and thermosetting plastic materials. The molding process typically involves feeding a material to be molded into a heated chamber for melting and then forced under pressure via flow paths into a mold cavity where the material cools and hardens to form a final molded part. The mold cavity is then opened and the final molded part is ejected from the mold cavity.

Conventional injection molding architecture comprises of a stationary mold plate and a movable mold plate, housing a mold cavity to form a molded article in between the mold plates. The mold plates are held together by a clamping arrangement during a molding cycle. Typically, the molded part is ejected from the cavity space of movable mold plate by a press-ejection mechanism, which involves a plurality of ejector pins sliding in unison through the movable plate in order to contact the surface of the molded part and dislodge the molded part. The ejector pins are actuated by an ejector plate for enabling the pins to slide through the mold plate and alternatively, backward movement of the movable mold plate which comprises respective channels to accommodate ejector pins that connect the press ejection mechanism to the ejector plate. Typically molds have ejector systems built into the moving half, the ejector pin travel must be sufficient to clear the molded material off the mold cavity.

When molded products and their respective molds are designed, the location of ejectors is important to ensure proper stripping from the core. By selecting suitable ejector components the visual appearance of the products can be considerably influenced, but it is even more important that the mold performance becomes more reliable and production improves. Ejector mechanisms further contains safety return pins or push back pins to reposition the ejector pins to the starting position, following ejection of the molded material. Press-Ejection mechanism also warrants precise control of timing, speed, and length of ejection stroke

However when the molded article does not typically fully harden during the cooling phase of the injection molding cycle, then ejection time has to be delayed until that article turns hard enough to be ejected. Another approach is to employ alternative methods of ejection such as manually pulling the molded part out of the mold or stripping the molded part off a mold cavity using an automated or semi-automated process.

For example, in the case of molded pet treats, if the pet treat dough or mix, from which the pet treat is molded, is not completely solidified at the time of mold opening then subsequent ejection process would damage the product. The damage occurs when all the ejector pins simultaneously press on the surface of molded pet treat in an attempt to eject, but eventually results in distortion of pet treat due to the pins penetrating through the non-hardened dough in one situation and partial or incomplete ejection of the molded pet treat from the mold cavity in certain cases.

Different functional designs of ejection pins adapted to eject the molded material from a mold are known in the art including: single unitary type pins with base portion fixed to the ejector plate; ejector pins adapted to slide through a movable mold plate, wherein the ejector pins are actuated by the movement of ejector plate; and ejector pins with base end flange portions linked to a cylinder rod of an air cylinder actuator, which is fixed to the ejector plate.

Ejection of an injection molded material from the mold cavity is also carried out by employing angular ejector pins configured to slide at an oblique angle into the mold plate for ejecting a plastic article molded in the injection mold. While mold opening, the angular ejector pin moving at an oblique angle ejects the plastic article out of the mold cavity of the injection mold.

Ejection mechanism or ejector devices of injection molding machines known in the art poses limitations such as synchronous movement of unitary ejector pins pushing the surface of a molded material may result in damaging at least parts of the molded material, especially in a non-solidified state during ejection. Further limitation includes additional wait time for allowing adequate solidification or cooling of the mold material before mold opening, which leads to delay in the molding process. In another scenario, during a conventional press type ejection process, the ejector pins may also leave unwanted impressions showing ejection spots on the surface of molded material, thus affecting the visual appeal of final molded product.

U.S. Pat. No. 6,491,512 B2 shows a two stage ejection system for an injection mold involving selective movement of mold plates during multistage ejection. U.S. Pat. No. 7,435,079 B2 discloses an angular ejector pin mechanism for ejecting plastic articles from an injection mold. U.S. Pat. No. 8,393,884 B2 shows an ejector device comprising a plurality of ejector rods removably fixed by magnetic rod fixing means. US patent publication number 20130251837 shows a type of injection molding machine employing toggle mechanism for ejection. US patent publication number 20060172037 shows ejection of molded part using a decelerated ejector pin.

Accordingly, there exists a need for an efficient method for ejecting a molded part or product from a mold cavity without damaging the molded part or product in an unsolidified or uncured state.

### SUMMARY OF THE INVENTION

The present invention relates to a perimeter ejector system for an injection molding apparatus comprising: a mold plate, housing a molded material within a mold cavity; and at least one lifting pin, forming an integral part of the mold cavity. The lifting pin comprises a push surface at least in part shaped to match the mold cavity profile, and is configured to extend through at least one side of the mold cavity for ejecting the molded material.

In an embodiment, the ejector system of the present invention comprises a retainer plate operatively coupled to an ejector plate, adapted to move towards the mold plate. The retainer plate holds the base portion of the lifting pin and movement of ejector retainer plate actuates the lifting pin to extend through the mold cavity from at least one side till the molded material is completely ejected out of the mold cavity.

In another embodiment, the ejector system for an injection molding apparatus comprises at least one lifting pin adapted to extend through the mold cavity from at least one side for ejecting the molded material. The lifting pin is gradually actuated by an actuator fixed to a mold back up plate. The actuator comprises a hydraulic drive or a pneumatic drive or a servomechanism or other similar actuation means for actuating the lifting pin.

### BRIEF DESCRIPTION OF DRAWINGS

FIG. 1A-1D shows a schematic illustration of perimeter ejection of a molded pet treat from a mold cavity, according to an embodiment of the present invention. FIG. 1A illustrates an initial position of the lifting pin in a perimeter ejection system. FIG. 1B illustrates initiation of perimeter ejection of the molded pet treat and FIG. 1C illustrates the lifting pin extending during perimeter ejection of the molded pet treat. FIG. 1D illustrates the lifting pin fully extended, completing the ejection of molded pet treat.

FIG. 2A shows a sectional view of a perimeter ejector system for an injection molding apparatus, according to an embodiment of the present invention.

FIG. 2B shows a sectional view of the perimeter ejection system during initiation of ejection, according to an embodiment of the invention.

FIG. 2C shows a sectional view of the perimeter ejection system illustrating the lifting pin extending during ejection, according to an embodiment of the invention.

FIG. 2D shows a sectional view of the perimeter ejection system illustrating the lifting pin fully extended out completing the ejection, according to an embodiment of the invention.

FIG. 3A shows a sectional view of a perimeter ejection system comprising a lifting pin driven by an actuator, according to an embodiment of the present invention.

FIG. 3B shows a sectional view of the perimeter ejection system during initiation of actuation of the lifting pin by the actuator, according to an embodiment of the invention.

FIG. 3C shows a sectional view of the perimeter ejection system illustrating the actuator extending during ejection, according to an embodiment of the invention.

FIG. 3D shows a sectional view of the perimeter ejection system illustrating the actuator fully extended out completing the ejection, according to an embodiment of the invention.

### DETAILED DESCRIPTION OF THE INVENTION

The structure and the technical means adopted by the present invention to achieve the above and other objects can be best understood by referring to the following detailed description of the preferred embodiments and the accompanying drawings.

The present invention relates to an ejector system for an injection molding apparatus, the system employs an improved method of ejection of a molded material from a mold cavity, without causing damage to any part of the molded material. Perimeter ejection of an injection molded material has broad applicability for a variety of molded materials, and is discussed below in a non-limiting context of a molded pet treat, comprising a pet food.

Perimeter ejector system according to an embodiment of the present invention comprises one or more lifting pins strategically placed over one or more corners or edges, allowing the pins to extend through the mold cavity for ejecting the molded material out of the cavity space. The lifting pins comprises a push surface at distal end, shaped to match the mold cavity, thus forming an integral part of the mold cavity. Perimeter ejection involves fluid motion of the lifting pin for gradual ejection of molded material, beginning from one of the corners or edges of the molded material. The lifting pin extends fully in order to completely eject the molded material out of the mold cavity.

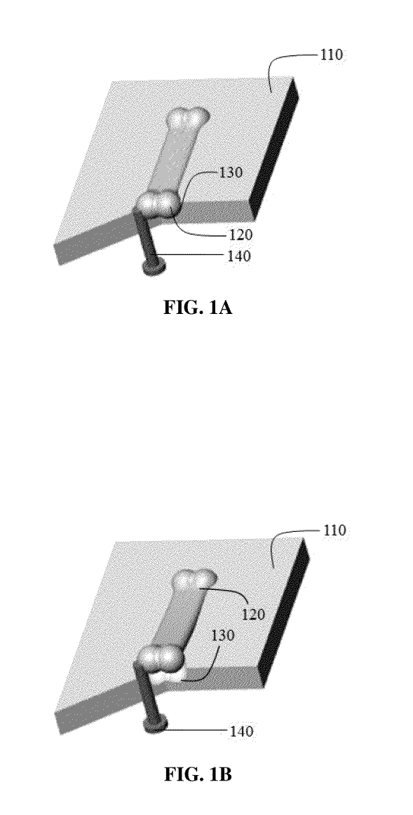

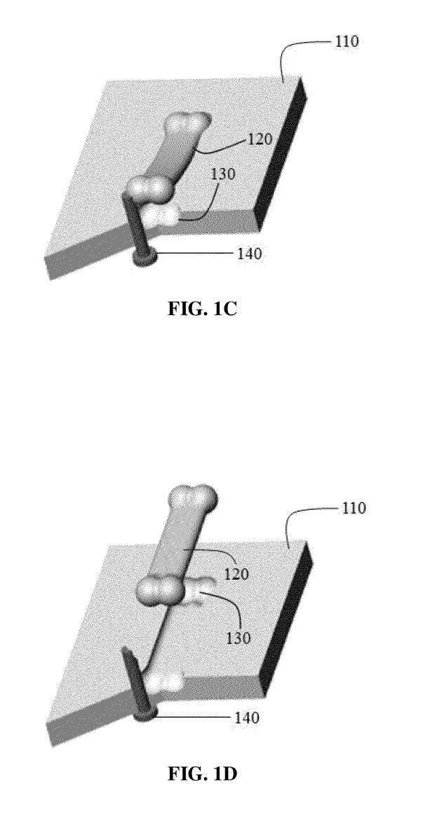

Referring to FIG. 1A-FIG. 1D, which schematically illustrates perimeter ejection of a molded pet treat 120 by a lifting pin 140, from a mold cavity 130 of a mold plate 110 according to an embodiment of the present invention. FIG. 1A illustrates an initial position of the lifting pin in a perimeter ejection system, with its push surface forming an integral part of mold cavity profile. FIG. 1B illustrates initiation of perimeter ejection of the molded pet treat and FIG. 1C illustrates the lifting pin extending during perimeter ejection of the molded pet treat. FIG. 1D illustrates the lifting pin fully extended, completing the perimeter ejection of molded pet treat.

The molded pet treat, which is molded from a dough or a mix comprising animal or pet food ingredients is prone to distortion during conventional ejection mechanisms employing synchronous movement of ejector pins through the mold plate in order to push the molded pet treat off the mold cavity, especially in an uncured state. Whereas, perimeter ejection according to an embodiment of the present invention comprises at least one lifting pin adapted to extend through at least one corner or edge of the mold cavity to push one of the corners or edges of molded material for gradual ejection of the molded material off the mold cavity.

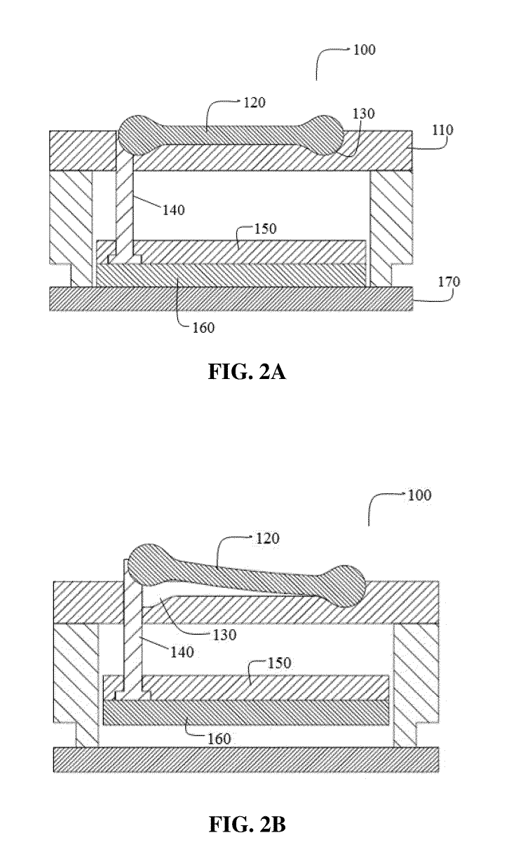

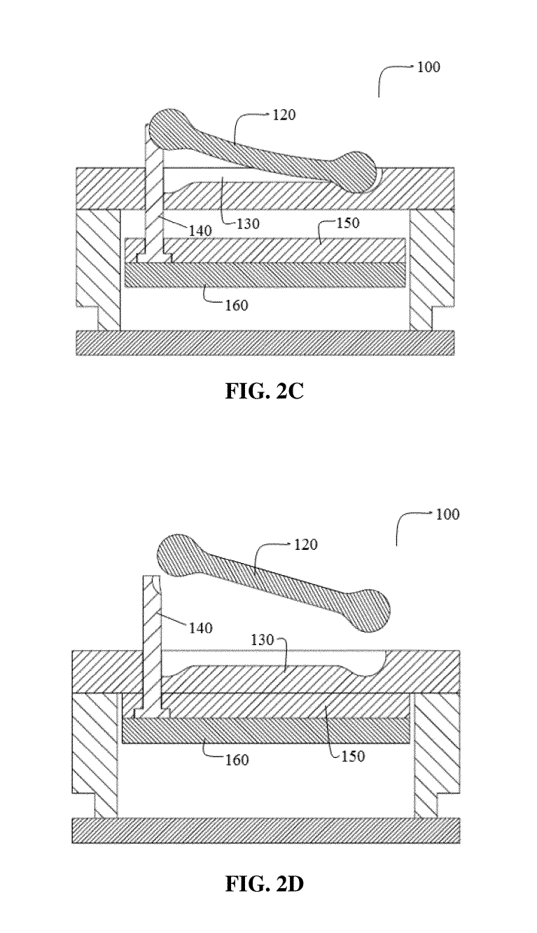

Referring to FIG. 2A-2D, which shows sectional views of the perimeter ejector system during ejection of molded pet treat. FIG. 2A shows a sectional view of an ejection system 100 in an initial position, the system 100 comprises a mold plate 110 housing a molded pet treat 120 in a mold cavity 130. The system 100 further comprises a retainer plate 150 operatively coupled with an ejector plate 160, adapted to move towards the mold plate 110 during ejection. A lifting pin 140 adapted to extend through at least one corner or edge of the mold cavity for ejecting the molded pet treat out of the cavity space 130. The retainer plate 150 holds the base portion of the lifting pin 140, which is actuated during the movement of ejector-retainer plate towards the mold plate 110. The system 100 further comprises a mold back up plate 170 in a fixed position adjacent to the ejector plate 160.

FIG. 2B shows a sectional view of the perimeter ejection system 100 during initiation of ejection. During ejection, the ejector plate 160 moves in unison with retainer plate 150 towards the mold plate, which in turn actuates the lifting pin 140 to extend through one of corners or edges of the mold cavity 130 of the mold plate to push the molded pet treat 120.

The ejector system may further comprise safety return pins or push back pins to reposition the lifting pin to the starting position, following ejection of the molded material during each molding cycle.

FIG. 2C shows a sectional view of the perimeter ejection system 100, illustrating the lifting pin extending during ejection. The ejector-retainer plate 160, 150 moves further towards the mold plate thereby further actuating the lifting pin 140 to extend through one of the corners or edges of the mold cavity 130 in order to further eject the molded pet treat 120 out of the mold cavity 130.

FIG. 2D shows a sectional view of the ejection system 100, illustrating the lifting pin fully extended out completing the ejection. The ejector plate 160 moves in unison with retainer plate 150 further closing in with the mold plate 110, thereby actuating the lifting pin 140 to fully extend through the one of the corners or edges of mold cavity 130 for completely ejecting the molded pet treat 120 out of the mold cavity 130.

The perimeter ejection system for an injection molding apparatus may also comprise a plurality of lifting pins actuated by ejector-retainer plate to extend the lifting pins through different corners or edges of the mold cavity in order to gradually peel the molded material off the cavity space.

In a different embodiment, the perimeter ejection system of the present invention comprises at least one lifting pin actuated by an actuator, wherein the actuator comprises a hydraulic drive or a pneumatic drive or a servomechanism or an electric actuator, thermal or magnetic actuator or mechanical actuator or other similar means of actuation.

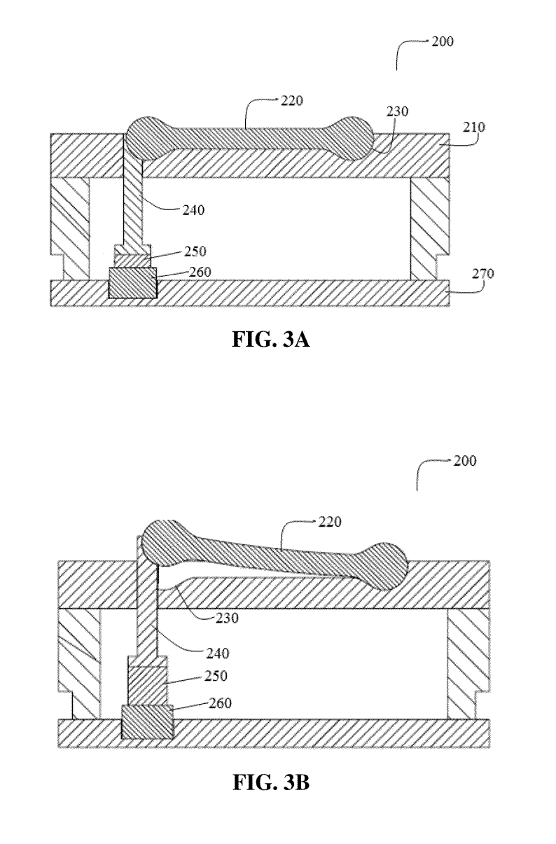

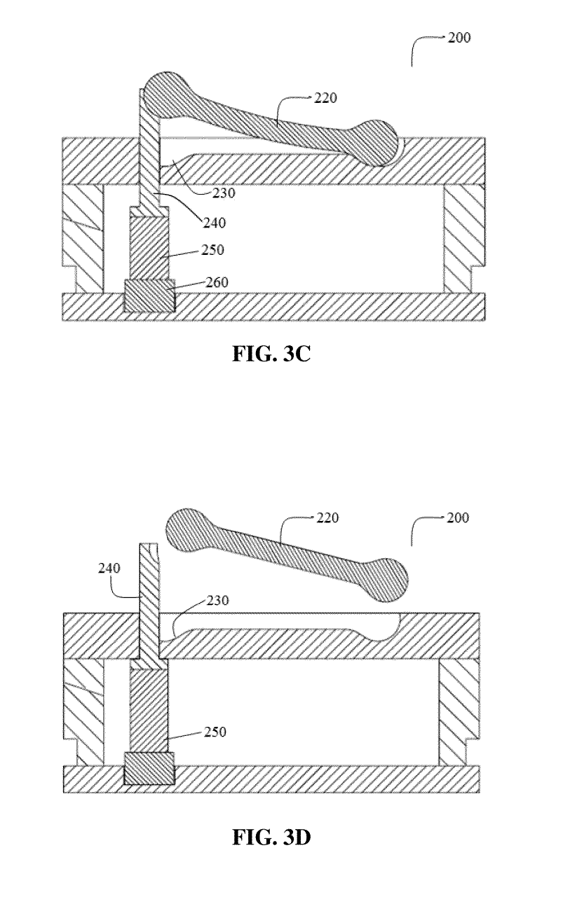

FIG. 3A shows a sectional view of a perimeter ejection system 200 comprising a lifting pin 240 driven by an actuator, at an initial position. The system 200 comprises a mold plate 210 housing a molded pet treat 220 in a mold cavity 230. At least one lifting pin 240 that can be actuated by an actuator, to extend through one of the corners or edges of the mold cavity 230 in order to eject the molded pet treat 220 off the mold cavity 230. The actuator comprises a cylinder 260 fixed to a back-up plate 270 and a movable piston rod 250 extending from the cylinder 260 to actuate the lifting pin 240.

FIG. 3B shows a sectional view of the perimeter ejection system 200, during initiation of actuation of the lifting pin 240 by the actuator. During actuation, the lifting pin 240 is actuated by the actuator, to extend through one of the corners or edges of the mold cavity 230 for ejecting the molded pet treat 220, in order to avoid damage to the molded material during ejection. The piston rod 250 begins to extend from the cylinder 260 during initiation of actuation of lifting pin 240.

FIG. 3C shows a sectional view of perimeter ejection system 200, illustrating the actuator extending during ejection. During actuation, the lifting pin 240 is further actuated by the actuator to further extend through one of the corners or edges of the mold cavity 230 for ejecting the molded pet treat 220. The piston rod 250 continues to extend from the cylinder 260 during actuation of lifting pin 240.

FIG. 3D shows a sectional view of perimeter ejection system 200, illustrating the actuator fully extended out completing the ejection. The piston rod 250 extends fully from the cylinder thereby actuating of lifting pin 240 to extend fully through the mold cavity 230 for ejecting the molded pet treat 220 completely out of the mold cavity 230.

One or more lifting pins extending through one or more edges or corners of the mold cavity can be employed. Each of the lifting pins can be actuated by an independent actuator, wherein actuation of each lifting pin can be timed and regulated by a preprogrammed or automatic control system.

The mold plate comprises an undercut portion as a part of the mold cavity, wherein the undercut comprises protrusions or recessions in a part that prevents the mold, after the molded part is formed, from sliding away along the parting direction.

Advantages of perimeter ejection according to an embodiment of the present invention include efficient ejection of molded materials or products from the injection mold without any deformation or damage to the product structure. By stripping the molded product out of their mold cavities from one or more corners or edges, a relatively small amount of force may be used to completely eject the product. Molded products such as pet treats made from dough or mix, can be ejected from one or more corners or sides or edges in order to prevent from damages, which normally occurs to the structure of molded material due to the forces applied by ejector pins while employing conventional ejection methods.

In an embodiment, the lifting pin is configured to contact a corner or an edge and push the molded material off the cavity from an oblique angle. The lifting pin disposed at an oblique angle helps in preventing structural distortion of the molded material due to direct forces exerted by the lifting pins that extends perpendicular to the mold surface.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A perimeter ejector system for an injection molding apparatus comprising:
a mold plate, housing a molded material within a mold cavity; and
at least one lifting pin, forming an integral part of the mold cavity by comprising a push surface at least in part shaped to match the mold cavity profile, wherein the lifting pin is configured to extend through at least one side of the mold cavity for ejecting the molded material.

2. The system of claim 1, further comprises a retainer plate which holds a base portion of the lifting pin, wherein the retainer plate is operatively coupled to an ejector plate.

3. The system of claim 2, wherein the ejector plate and retainer plate is adapted to move towards the mold plate for actuating the lifting pin to extend through the mold cavity.

4. The system of claim 2, wherein the lifting pin extends through the mold cavity till the molded material is ejected out completely out of the mold cavity.

5. The system of claim 1, further comprises a mold back up plate.

6. The system of claim 1, wherein the molded material comprises a molded pet treat.

7. The system of claim 1, wherein the mold cavity comprises at least one undercut portion.

8. The system of claim 1, wherein the lifting pin is actuated by an actuator.

9. The system of claim 8, wherein the actuator comprises a hydraulic drive or a pneumatic drive or a servomechanism or an electric actuator, a thermal actuator or a magnetic actuator or a mechanical actuator, for actuating the lifting pin.
